(19) United States
(12) Patent Application Publication
(10) Pub. No.: US 2006/0257228 A1
(43) Pub. Date: Nov. 16, 2006

(54) Locking ring

(76) Inventor: Werner Jacob, Frankfurt (DE)

Correspondence Address: JACOBSON HOLMAN PLLC, 400 SEVENTH STREET N.W., SUITE 600, WASHINGTON, DC, 20004, US

(21) Appl. No.: 10/550,943

(22) PCT Filed: Mar. 29, 2004
(86) PCT No.: PCT/DE04/00650

§ 371 Date: Sep. 28, 2005

(30) Foreign Application Priority Data
Mar. 28, 2003 (DE) 10314202.9

(51) Int. Cl. F16B 39/24

(52) U.S. Cl. 411/147

(57) ABSTRACT

The invention relates to a locking ring for axially fixing a shaft part (3) in a ring part (1). The locking ring (5) has first partial areas (56, 57, 51, 53) which engage in the inner groove (21) after resiliently pressing together the locking ring (5) so that it can be placed in the inner opening (21) of the ring part (1), pushing the safety ring (5) into the area of the inner groove (4) and releasing and resiliently placing the locking ring (5). The locking ring also has second partial areas (52, 54, 55) that project from the inner groove (21) once the safety ring (5) has been placed in the inner groove (21) and which are resiliently pushed outward in a phase (7) of the shaft part (3) which has been pushed into the inner opening (2) so that the safety ring (5) can slide on the periphery of the shaft part (3) until it reaches the area of the peripheral groove (4) and the second partial areas (52, 54, 55) resiliently snap onto said peripheral groove.

This is a nationalization of PCT/DE2004/000650 filed 29 Mar. 2004 and published in German.

The present invention relates to a locking ring according to the preamble of main claim 1.

Locking rings of such type are well-known. For example, the patent specification DE 41 09 481 C2 describes a circlip that has an annular hole for resiliently slipping into an inner groove that has a sloping side or for turning into an inner hole of a ring part. An outer groove with radial clearance is mounted on a pin, especially for axially securing a releasable serrated connection between the ring part and the pin. For the purpose of mounting, the circlip is bent up and pushed on the pin till it engages in its outer groove. Subsequently, the pin with the mounted circlip is inserted into the inner opening of the ring part that is provided with sloping ends, where the circlip is pressed together and expands radially on reaching the inner groove of the ring part, in order to interlock the pin and the ring part axially.

A problem of such a type of circlip is that it is not centered ideally after being mounted on the pin in its outer groove. Consequently, the insertion of the circlip into the ring part is disadvantageous because a large phase and/or sloping ends of the ring part are required for inserting the pin with the mounted circlip in the inner opening of the ring part or a special servomechanism is necessary for this purpose.

Therefore the objective of the present invention is to create a locking ring that is centered comparatively more precisely in the inner groove of the ring part even before joining the connection between the shaft part and a disk part or ring part, so that when inserting the shaft part to be attached to the ring part, an easily reproducible force develops for opening the locking ring on a phase of the shaft part.

This objective is solved by a locking ring having the characteristics specified in the claim 1.

The essential advantage of the present locking ring is that when establishing a connection between a shaft part and the ring part, a very easily reproducible force develops for opening the ring in the region of the sloping ends and/or the phase of the shaft part. Thus, it is possible to easily record and demonstrate the secure engaging of the locking ring by monitoring the force during the process of mounting. The present locking ring can be created advantageously such that there are no problems related to imbalance during its use even at a high number of rotations.

It is of particular significance and advantage that the end areas on the opening and/or partition of the locking ring according to the present invention are arranged in the inner groove of the ring part after the locking ring expands. As a result, these end areas cannot be displaced axially particularly when inserting the shaft part.

Advantageously, no special servomechanism is necessary when creating the connection between the shaft part and the ring part.

In a preferred embodiment of the present invention, the inner groove of the shaft part is beveled obliquely on at least one side, so that it is possible to release the connection between the shaft part and the ring part by applying a sufficiently high axial force. As opposed to that, in case of sharp-edged inner grooves of the shaft part, the connection between the shaft part and the ring part can be released only by forcibly shearing off the locking ring.

The present locking ring can have a triangular or rectangular, oval or elliptical material cross-section, where it is particularly advantageous if the locking ring enters as evenly as possible over the periphery of the shaft part for being placed in the inner opening, once the shaft part is inserted into the ring part, in the groove of which the locking ring is inserted.

Preferred embodiments of the present invention are specified in the characteristics of the dependent claims.

The present invention and its embodiments are explained more elaborately in the following description on the basis of the figures, of which:

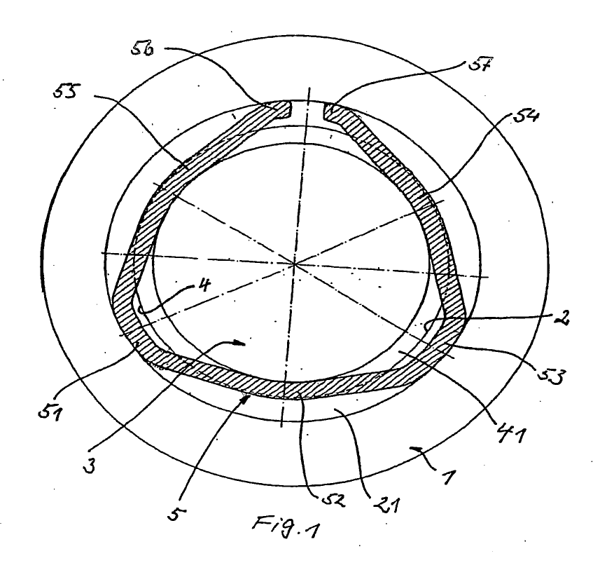

FIG. 1: illustrates a cross-section of the mounted, locking ring according to the invention. Said locking ring creates a connection between a shaft part and a ring part;

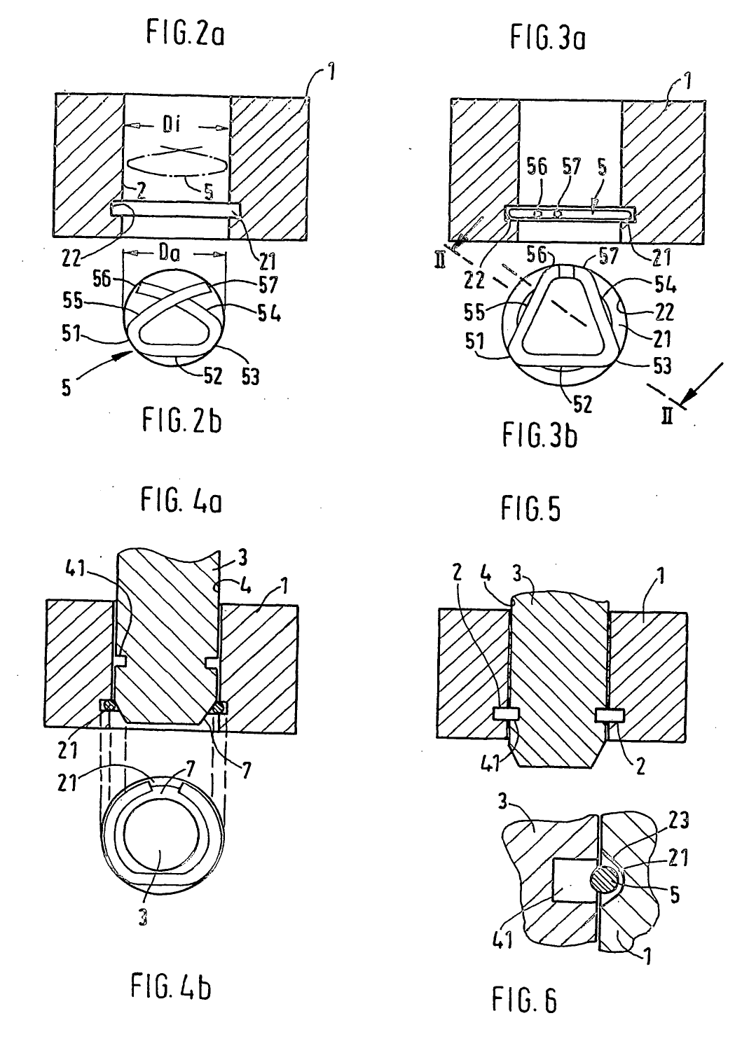

FIGS. 2a and 2b illustrate the cross-section of the ring part as well as the cross-section of the locking ring that is spirally pressed together for insertion into the inner groove of the ring part;

FIGS. 3a and 3b illustrate the cross-section of the ring part and a cross-section of the locking ring according to the invention that is inserted into the inner groove of the ring part;

FIGS. 4a and 4b illustrate the cross-section of the ring part as well as the shaft part which is inserted straight into the inner opening of the ring part and/or the cross-section of the locking ring according to the invention, which is widened on the phase of the shaft part;

FIG. 5 illustrates the cross-section of the ring part and of the shaft part connected to it; and

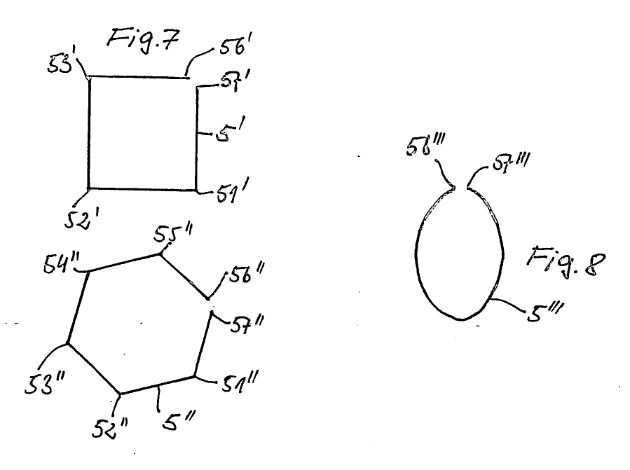

FIGS. 6 to 8 illustrate additional embodiments of the invention.

An annular ring part is marked with 1 in FIG. 1. The shaft part and the present locking ring are marked with 3 and 5 respectively.

The annular ring part 1 comprises a circular inner opening 2, in which an annular inner groove 21 is arranged. An annular outer peripheral groove 41 is arranged in the outer periphery 4 of the shaft part 3.

According to a preferred embodiment, the locking ring 5 essentially comprises a base part 52 and lateral side parts 54, 55, that are arranged in it and that have a triangular shape together, where preferably the opposite free ends 57 and 58 of the side parts 54, 55 are located with a gap between each other in the peripheral direction. The base part 52 is connected to the side part 54 using a preferably rounded corner area 53. Accordingly, the base part 52 is connected to the side part 55 using a preferably rounded corner area 51. The shape corresponds preferably to an equilateral triangle, where the end areas 56, 57 are arranged in the area of the third corner.

FIG. 1 illustrates the mounted state of the present locking ring 5, in which at least the corner areas 51, 53 and the corner areas 56, 57 engage in the inner groove 21 of the ring part 1 and at least the middle areas of the base part 53 and of the side parts 54 and 55 engage in the peripheral groove 41 of the shaft part 3 in order to interlock the ring part 1 and the shaft part 3, so that they are fixed to one another in the axial direction against radial movements.

The assembly steps for connecting the ring part 1 with the shaft part 3 are explained more elaborately in the following description on the basis of the FIGS. 2 to 4.

First, before the shaft part 3 is inserted into the ring part 1 of the locking ring 5, the base part 52 and the side parts 54 and 55 of the latter are pressed together preferably in a linear and spiral manner according to FIG. 2b so that its outer diameter Da is smaller than the inner diameter Di of the inner opening 2 of the ring part 1. Subsequently, the thus pressed locking ring 5 is pushed into the ring part 1 in the axial direction so far till it reaches the area of the inner groove 21. The locking ring 5 is then released, so that it snaps resiliently with its corner areas 51, 53 and the corner areas 56, 57 onto the base wall 22 of the inner groove 21. This state is illustrated in the FIGS. 3a and 3b, where in FIG. 3b, the location of the locking ring 5 is marked by the cross-section II-II in the FIG. 3a.

According to FIG. 4, the shaft part 3 is inserted into the inner opening 2 of the ring part 1, where the shaft part 3 has a phase 7 and/or sloping area on its front end as seen from the direction of insertion. This phase 7 engages in the inner area of the locking ring 5 and expands it during the continued insertion of the shaft part 3 in the inner opening 2 due to the constantly increasingly diameter of the phase 7, till it snaps resiliently against the outer periphery 4 of the shaft part 3. A state in which the locking ring 5 is expanded on the phase 7 is illustrated in FIG. 4b.

The shaft part 3 is now pushed so far in the direction of insertion, till the peripheral groove 41 reaches into the area of the inner groove 21 and of the locking ring 5 arranged in it, where the areas of the locking ring 5 lying against the outer periphery of the shaft part 3 (particularly the middle areas of the base part 51 and the side parts 54, 55) resiliently snap onto the inner groove 21 in order to lock the shaft part 3 on the ring part 1 and the side parts 54, 55 deformed outward in a bow shape illustrated in FIG. 1 and the base part 52 lock resiliently at the base of the peripheral groove 41 of the shaft part 3 and the corner areas 51, 53 and the end areas 56, 57 lock resiliently at base 22 of the inner grove 21 of the ring part 1.

In the following description the locking ring has a triangular shape. However, even other forms, for example oval or elliptical or polygonal shapes are also feasible, whereby it depends on whether the part areas (preferably rounded corner areas) of the locking ring rest against the base of the inner groove 21 of the ring part 1 and other partial areas (preferably areas between the corner areas) rest against the base of the inner groove 21 of the shaft part 3 in the mounted state of the locking ring. In the design forms of the locking ring that are particularly preferred the said resting points of the part areas are distributed as evenly as possible around the inner periphery of the inner groove 41 and/or of the peripheral groove 21.

FIG. 6 illustrates an additional embodiment of the present invention in which the peripheral groove 41 of the shaft part 3 has two side walls 23 that extend obliquely in the axial direction so that it is possible to detach the created connection between the ring part 1 and the shaft part 3 by applying an appropriate force in both the axial directions, where the locking ring 5 is expanded on an obliquely extending side wall 23 in such a manner that its partial areas engaging in the inner groove 21 project from the inner groove 21. One or two corresponding, oblique sidewalls can also be provided on the peripheral groove 41 in order to press out the partial areas of the locking ring 5 out of the peripheral groove 41 when pressure is applied in the axial direction.

FIG. 7 illustrates schematically additional preferred embodiments of the present locking ring 5′ and 5″ having a quadratic and/or a pentagonal shape. Polygonal shapes with more than four or five corners are also feasible.

FIG. 8 illustrates a locking ring 5′″ with an oval form. An elliptical shape is also feasible.

It is of particular significance in connection with the present invention that the corner areas of the safety ring 5, 5′, 5″, 5′″ are each placed in the area of the opening and/or partition of the locking ring 5, 5′, 5″, 5′″ and that the opening and/or partition is present at the largest diameter of the locking ring 5, 5′, 5″, 5′″. In this way it is ensured that the end areas 56, 57, 56′, 57′, 56″, 57″, 56′″, 57′″ of the locking ring 5, 5′, 5″, 5′″ are arranged after the insertion of the locking ring into the ring part 1 and after the displacement to the inner groove 21 of the ring part 1 as well as after the expansion of the locking ring 5, 5′, 5″, 5′″ in the inner groove 21 of the ring part 1. By this arrangement of the end areas 56, 57, 56′, 57′, 56″, 57″, 56′″, 57′″ in the inner groove 21, during the mounting steps when inserting the shaft part 3 and even thereafter in the mounted state, the end areas 56, 57, 56′, 57′, 56″, 57″, 56′″, 57′″, which preferably are resiliently supported, are prevented from being moved and/or pushed to the base wall 22 of the inner groove 21 of the ring part 1. Thus a particularly good axial fixing of the locking ring 5, 5′, 5″, 5′″ on the ring part 1 is achieved. The corner areas 51, 53, 51′, 52′, 53′, 51″, 52″, 53″, 54″, 55″ of the described embodiments of the FIGS. 1, 7 and 8 also engage resiliently in the mounted state in the inner groove 21 of the ring part 1. The middle areas lying between two corner areas and/or between two areas of the largest diameter each engage in the outer groove 41 of the shaft part 3 resiliently in order to fix the shaft part axially and in relation to the ring part 1.

1. Locking ring for axially fixing a shaft part (3) in a ring part (1), where the shaft part (3) has an peripheral groove (41) and the ring part (1) has an inner groove (21), in which the locking ring (5) comprising an opening in the circumferential direction engages in the fixed state, characterized in that the locking ring (5) has first partial areas (56.57, 51,53), that engage in the inner groove (21) after the resiliently pressing together the locking ring (5), so that so that it can be placed in the inner opening (21) of the ring part (1), pushing the locking ring (5) into the area of the inner groove (21) and releasing and expanding the locking ring (5) and also has second partial areas (52, 54, 55) that project from the inner groove (21) once the locking ring (5) has been placed in the inner groove (21) and which are resiliently pushed outward in a phase (7) of the shaft part (3) which has been pushed into the inner opening (2) so that the safety ring (5) can slide on the periphery of the shaft part (3) until it reaches the area of the peripheral groove (41) and the second partial areas (52, 54, 55) resiliently snap onto said peripheral groove.

2. Locking ring pursuant to claim 1, characterized in that, the first and second partial areas are each distributed evenly over the periphery of the inner groove (21) and/or the peripheral groove (41).

3. Locking ring pursuant to claim 1, characterized in that, it has the shape of a triangle formed from a base part (52) and two side parts (54, 55) connected to the former, where the first partial areas are formed by the two corner areas (51, 53) between the base part and the side parts and the free end areas (56, 57) of the side parts of the triangle and the second partial areas are formed by the middle areas of the base part (52) and the side parts (54, 55).

4. Locking ring pursuant to claim 3, characterized in that, the side parts (54, 55) and the base part (52) form an equilateral triangle.

5. Locking ring pursuant to claim 1, characterized in that, it has the shape of a triangle (5′; 5″) with side parts and corner areas, where the first partial areas are formed by the corner areas (51′, 52′, 53′; 51″, 52″, 53″, 54″, 55″) and the free end areas (56′, 57′; 56″, 57″) adjoining the opening of the locking ring (5′; 5″) and where the second partial areas are formed by the middle areas of the side parts of the triangle.

6. Locking ring pursuant to claim 1, characterized in that, it has an oval or elliptical shape, where the first partial areas are formed by areas of the largest diameter of the locking ring (5′″), where the opening and the end areas (56′″, 57′″) of the locking ring are arranged in an area of the largest diameter of the locking ring (5′″) and where the second partial areas are formed by their middle areas of the locking ring (5′″) that lie between the areas of the largest diameter.

7. Locking ring pursuant to claim 1, characterized in that, the corner areas (51, 53) are rounded off.

8. Locking ring pursuant to claim 7, characterized in that, the rounding of the corner areas (51, 53) is adjusted to the radius of the base (22) of the inner groove (21).

9. Locking ring pursuant to claim 1, characterized in that, it has a circular, oval, rectangular, quadratic or polygonal design in its material cross-section.
